(19) United States
(12) Patent Application Publication
(10) Pub. No.: US 2026/0012282 A1
(43) Pub. Date: Jan. 8, 2026

(54) MODE DIVISION MULTIPLEXING USING COMBINED DEGENERATE MODES

(71) Applicants: CORNING INCORPORATED, CORNING, NY (US); President and Fellows of Harvard College, Cambridge, MA (US)

(72) Inventors: Federico Capasso, Cambridge, MA (US); Paulo Clovis Dainese, Jr., Painted Post, NY (US); Ahmed Hassen Dorrah, Eindhoven (NL); Ming-Jun Li, Horseheads, NY (US); Jaewon Oh, Cambridge, MA (US); Jun Yang, Los Gatos, CA (US)

(21) Appl. No.: 18/992,324

(22) PCT Filed: Aug. 9, 2023
(86) PCT No.: PCT/US2023/029807

§ 371 Date: Jan. 8, 2025

Related U.S. Application Data
(60) Provisional application No. 63/398,251, filed on Aug. 16, 2022.

(51) Int. Cl. H04J 14/04

(52) U.S. Cl. CPC H04J 14/04

(57) ABSTRACT

An optical communication system can include a multiplexer/demultiplexer. The multiplexer/demultiplexer can transfer a first optical data signal between a first single-mode fiber and a first propagation mode of a few-mode fiber. The first propagation mode can have a first effective refractive index. The multiplexer/demultiplexer can transfer a second optical data signal between a second single-mode fiber and a combination of a second propagation mode of the few-mode fiber and a third propagation mode of the few-mode fiber. The second propagation mode and the third propagation mode can have a same effective refractive index that differs from the first effective refractive index. During propagation within the few-mode fiber, the second optical data signal can couple bidirectionally between the second propagation mode and the third propagation mode, while being substantially isolated from the first optical data signal in the first propagation mode.

### CROSS-REFERENCE TO RELATED APPLICATIONS

This application claims the benefit of priority under 35 U.S.C. § 119 of U.S. Provisional Application No. 63/398,251 filed Aug. 16, 2022, the content of which is incorporated herein by reference in its entirety.

### FIELD OF THE DISCLOSURE

The present disclosure relates generally to multiplexing and demultiplexing of signals in an optical fiber, such as by mode division multiplexing.

### BACKGROUND OF THE DISCLOSURE

Communication systems can use multiplexing techniques to combine multiple optical signals onto a single optical fiber. There is ongoing effort to improve multiplexing techniques.

### SUMMARY

In an example, an optical communication system can include: a multiplexer/demultiplexer configured to: transfer a first optical data signal between a first single-mode fiber and a first propagation mode of a few-mode fiber, the first propagation mode having a first effective refractive index; and transfer a second optical data signal between a second single-mode fiber and a combination of a second propagation mode of the few-mode fiber and a third propagation mode of the few-mode fiber, the second propagation mode and the third propagation mode having a same effective refractive index that differs from the first effective refractive index.

In an example, a method for operating an optical communication system can include: coupling, with a multiplexer/demultiplexer, a first optical data signal between a first single-mode fiber and a first propagation mode of a few-mode fiber, the first propagation mode having a first effective refractive index; and coupling, with the multiplexer/demultiplexer, a second optical data signal between a second single-mode fiber and a combination of a second propagation mode of the few-mode fiber and a third propagation mode of the few-mode fiber, the second propagation mode and the third propagation mode having a same effective refractive index that differs from the first effective refractive index.

In an example, an optical communication system can include: a multiplexer configured to: transfer a first optical data signal from a first single-mode fiber of a first single-mode fiber array to a first propagation mode of a few-mode fiber, the first propagation mode having a first effective refractive index; and transfer a second optical data signal from a second single-mode fiber of the first single-mode fiber array to at least one of a second propagation mode of the few-mode fiber and a third propagation mode of the few-mode fiber, the second propagation mode and the third propagation mode having a same effective refractive index that differs from the first effective refractive index; and a demultiplexer configured to: transfer the first optical data signal from the first propagation mode of the few-mode fiber to a third single-mode fiber of a second single-mode fiber array; and transfer the second optical data signal from the combination of the second propagation mode of the few-mode fiber and the third propagation mode of the few-mode fiber into a fourth single-mode fiber of the second single-mode fiber array.

### BRIEF DESCRIPTION OF THE DRAWINGS

FIG. 1 shows a block diagram of an example of an optical communication system.

FIG. 2 shows a side-view drawing of an example of a configuration for one or more metasurface elements of the multiplexer/demultiplexer of FIG. 1.

FIG. 3-7 show side-view drawings of various example of a configuration for the multiplexer/demultiplexer of FIG. 1.

FIG. 8 shows a flow chart of an example of a method for operating an optical communication system.

Corresponding reference characters indicate corresponding parts throughout the several views. Elements in the drawings are not necessarily drawn to scale. The configurations shown in the drawings are merely examples and should not be construed as limiting in any manner.

### DETAILED DESCRIPTION

An optical fiber can be designed to confine and guide light in its interior. For example, a rotationally symmetric fiber can have a cross-section that includes a circular core surrounded by a circular cladding of a lower refractive index. In a simple ray-optics picture, total internal reflection at the core-cladding interface can occur for a particular range of propagation angles. The total internal reflection, along with use of materials that have low absorption and low scattering, can allow light to travel through long lengths of the fiber. An optical fiber can support multiple spatial modes, which are eigenstates of the wave-equation for a given translation-invariant refractive index profile. In general, as the core diameter increases or the difference in refractive index between core and cladding increases, the number of propagation modes supported by the fiber also increases. When the core diameter or index difference is reduced beyond a specified threshold diameter (which is a function of the wavelength of the light and the refractive indices of the core and cladding), the fiber can support only a single propagation spatial mode (with two polarization states). A fiber that supports only a single propagation mode is referred to as a single-mode fiber.

There is a class of fibers known as few-mode fibers, which support more than a single propagation mode. For example, a few-mode fiber can support two propagation modes, three propagation modes, four propagation modes, five propagation modes, six propagation modes, ten or fewer propagation modes, twenty or fewer propagation modes, or another suitable finite number of propagation modes.

The refractive index profile in rotationally symmetric circular fibers depends only on the radial coordinate. In step-index fibers, both core and cladding have constant refractive indices (with the core index higher than the cladding). Some optical fibers have a parabolic-shaped index profile, in which the refractive index is reduced quadratically with the radial coordinate. Other fibers can have more complex index profiles such as for example a ring-shaped core that is surrounded by a cladding (e.g., low index material is disposed inside the ring-shaped core and outside the ring-shaped core). Another example of a few-mode fiber can have a cross-section, taken in a plane that is orthogonal to the longitudinal axis of the fiber, that includes a core that is elongated along a particular direction, as an elliptically shaped core. Other few-mode fiber geometries can also be used.

Each propagation mode supported by a few-mode fiber has three properties. A first property is a spatially varying intensity distribution (or, equivalently, an electric field distribution and/or a magnetic field distribution). In some examples, the spatially varying transverse intensity distribution has an intensity that peaks on the core and decreases at increasing distance away from the core. A second property is a spatially varying polarization distribution, such as a direction of the electric field and/or magnetic field throughout a cross-section of the fiber. In some examples, the polarization distribution varies from mode to mode. A third property is the effective refractive index of the propagation mode. The effective refractive index is a single, scalar numerical value that is calculable from the spatially varying intensity distribution and the spatially varying polarization distribution, such as by a weighted average over the cross-sectional area of the fiber. For example, if there is more optical power (e.g., such as by having a higher light intensity) in the core than in the cladding, then the effective refractive index can be closer to the core refractive index than the cladding refractive index. The effective refractive index can be greater than or equal to a refractive index of the cladding and less than or equal to a refractive index of the core. Depending on the symmetry of the geometry of the core and cladding, the effective refractive indices of two or more propagation modes may be equal. For example, modes in rotationally symmetric fibers can always be classified as transverse magnetic (TMₘₙ), transverse electric (TEₘₙ) or hybrid (HEₘₙ/EHₘₙ). In general, for rotationally symmetric fibers, every hybrid mode is doubly degenerate, meaning there are always two modes HE_{mn,a} and HE_{mn,b} that have the same exact effective refractive index. The transverse magnetic and transverse electric are not necessarily doubly degenerate in a rotationally symmetric fiber with low loss.

Few-mode fibers can be used in optical communication systems by employing mode division multiplexing. For example, light beams corresponding to different data channels can be spatially combined and injected into respective propagation modes of the fiber. In an ideal fiber, light propagates along the fiber in a specific mode without coupling into another mode. In practice, perturbations such as bends, twists, distributed or localized stresses, and/or splicing points can cause coupling between different modes. This coupling is referred to as crosstalk between propagation modes.

One obstacle in employing mode division multiplexing in a few-mode fiber is that degenerate modes (i.e., propagation modes having the same effective refractive index) have a relatively high crosstalk with one another. For example, during propagation in a few-mode fiber, light can transfer randomly between propagation modes that have equal effective refractive indices (in a condition referred to as degeneracy). As a specific example, light that is injected into a first of two degenerate propagation modes can transfer randomly between the two degenerate propagation modes as it propagates along the fiber, and can emerge from the fiber in a combination of the two degenerate propagation modes, with the relative amount in one mode being a random (or otherwise unpredictable) number between 0% and 100% and the relative amount in the other mode being 100% minus the random number.

To overcome the obstacle of high crosstalk between degenerate propagation modes in a few-mode fiber, a demultiplexer can combine the light from the degenerate modes to form a single data channel. A corresponding multiplexer can launch the light into any or all of the degenerate modes. As the light propagates, the propagation can randomize how much of the light is in each of the degenerate modes. By combining the light from some or all of the degenerate modes to form a single data channel, the effect of the degenerate mode crosstalk is reduced or negated.

In an example of an optical communication system, a multiplexer/demultiplexer can transfer a first optical data signal between a first single-mode fiber and a first propagation mode of a few-mode fiber. The first propagation mode can have a first effective refractive index. The multiplexer/demultiplexer can transfer a second optical data signal between a second single-mode fiber and a combination of a second propagation mode of the few-mode fiber and a third propagation mode of the few-mode fiber. The second propagation mode and the third propagation mode can have the same effective refractive index that differs from the first effective refractive index. During propagation within the few-mode fiber, the second optical data signal can couple bidirectionally between the second propagation mode and the third propagation mode, while being substantially isolated from the first optical data signal in the first propagation mode.

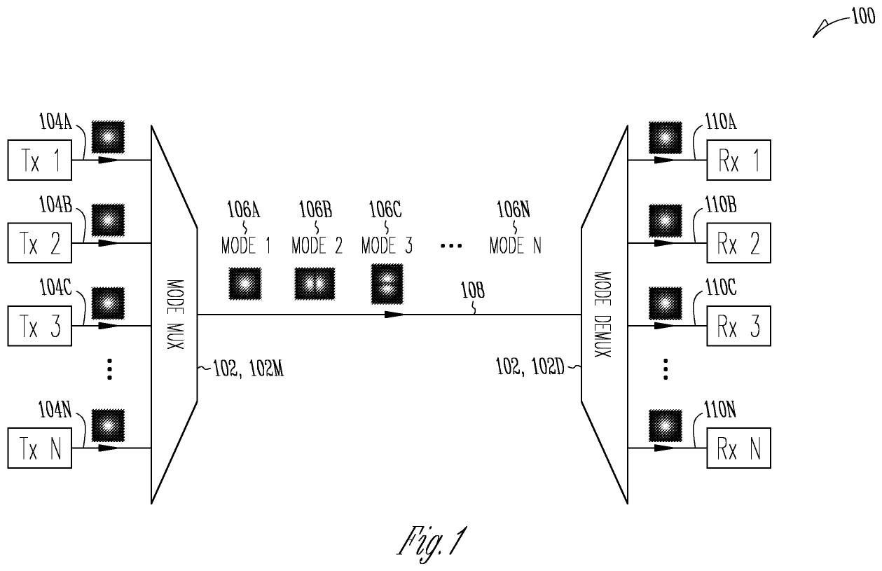

FIG. 1 shows a block diagram of an example of an optical communication system 100.

The optical communication system 100 can include a multiplexer/demultiplexer 102. The multiplexer/demultiplexer 102 can process optical data signals, which include optical beams onto which digital and/or analog data signals have been encoded, such as by quadrature amplitude modulation, amplitude and phase-shift keying, asymmetric phase-shift keying, or another suitable encoding/decoding scheme. The multiplexer/demultiplexer 102 can use a modulator 102M to combine multiple optical data signals from respective single mode fibers 104A, 104B, 104C, . . . , 104N onto a single fiber, transmit the multiple optical data signals along arbitrarily long lengths of the fiber, and use a demodulator 102D to separate the signals into the original optical data signals and direct the separated signals into respective single-mode fibers 110A, 110B, 110C, . . . , 110N. The optical communication system 100 can use mode division multiplexing to direct the optical data signals onto respective propagation modes 106A, 106B, 106C, . . . , 106N (or combinations of modes) of a few-mode fiber 108, as discussed in detail below.

The multiplexer/demultiplexer 102 can transfer a first optical data signal between a first single-mode fiber 104A and a first propagation mode 106A of a few-mode fiber 108. In some examples, the first propagation mode 106A can be a transverse electric mode or a transverse magnetic mode of the few-mode fiber 108. The first propagation mode 106A can have a first effective refractive index.

The multiplexer/demultiplexer 102 can transfer a second optical data signal between a second single-mode fiber 104B and a combination of a second propagation mode 106B of the few-mode fiber 108 and a third propagation mode 106C of the few-mode fiber 108. The second propagation mode 106B and the third propagation mode 106C can have a same effective refractive index that differs from the first effective refractive index. In some examples, the second propagation mode 106B and the third propagation mode 106C can each be a hybrid electric mode of the few-mode fiber 108.

In some examples, a cross-section of a core of the few-mode fiber 108, taken orthogonal to a longitudinal axis of the few-mode fiber 108, has a ring shape. In some examples, the first propagation mode 106A includes only light having a polarization orientation that is parallel to the radial direction or only light having a polarization orientation that is parallel to the tangential direction. In some examples, the second propagation mode 106B and the third propagation mode 106C can each include at least some light having a polarization orientation that is angled with respect to the radial direction and angled with respect to the tangential direction. The ring shape is but one example of a core cross-sectional shape for the few-mode fiber 108. In some examples, the cross-sectional shape for the core of the few-mode fiber 108 can include multiple rings that are optionally concentric. In some examples, the cross-sectional shape for the core of the few-mode fiber 108 can include one or more step-index features, such as features in which a core material has a first refractive index and a cladding material has a second refractive index different from the first refractive index. In some examples, the cross-sectional shape for the core of the few-mode fiber 108 can include one or more gradient-index features, such as features in which a refractive index varies continuously (or in relatively small steps) to define a core and a cladding. For such gradient-index features, the geometry of the gradient-index material defines the propagation modes. In some examples, the cross-sectional shape for the core of the few-mode fiber 108 can be rotationally symmetric about a longitudinal axis of the few-mode fiber 108. Such rotational symmetry can simplify coupling to and from the few-mode fiber 108, because the rotational symmetry can eliminate the need to maintain an azimuthal alignment when performing the coupling. Other configurations can also be used.

If the second propagation mode 106B and the third propagation mode 106C have the same effective refractive index (such that the second propagation mode 106B and the third propagation mode 106C are degenerate), the second optical data signal can couple bidirectionally between the second propagation mode 106B and the third propagation mode 106C. In other words, the second optical data signal can transfer randomly between the second propagation mode 106B and the third propagation mode 106C as the second optical data signal propagates along a length of the few-mode fiber 108.

The second optical data signal can be substantially isolated from the first propagation mode 106A. The first optical data signal can be substantially isolated from the second propagation mode 106B and substantially isolated from the third propagation mode 106C. For the purposes of this document, the phrase “substantially isolated” is intended to mean that crosstalk between modes that are substantially isolated from one another has a coupling ratio that is less than or equal to a specified threshold, such as −30 dB. Such crosstalk can be caused by propagation along the few-mode fiber 108. For example, light coupling from the first propagation mode 106A to the second propagation mode 106B can have a signal power in the second propagation mode relative to the signal power in the first propagation mode of −30 dB or less (corresponding to a fraction of 0.001 or less). As a practical matter, if a spurious optical data signal at −30 dB is added to a desired optical data signal at 0 dB, the spurious optical data signal at −30 dB can be filtered out as noise, leaving only the desired optical data signal at 0 dB. Other suitable specified threshold values can also be used, including −10 dB, −15 dB, −20 dB, −25 dB, −35 dB, −40 dB, and others.

In some examples, the multiplexer/demultiplexer 102 includes a multiplexer 102M. The multiplexer 102M can transfer the first optical data signal from the first single-mode fiber 104A to the first propagation mode 106A of the few-mode fiber 108. The first propagation mode 106A can have a first effective refractive index. The multiplexer 102M can transfer the second optical data signal from the second single-mode fiber 104B to at least one of the second propagation mode 106B of the few-mode fiber 108 and the third propagation mode 106C of the few-mode fiber 108. The second propagation mode 106B and the third propagation mode 106C can have the same effective refractive index, which differs from the first effective refractive index. Because the second propagation mode 106B and the third propagation mode 106C can have the same effective refractive index, the second propagation mode 106B and the third propagation mode 106C can be degenerate.

In some examples, the multiplexer/demultiplexer 102 can include a demultiplexer 102D. The demultiplexer 102D can transfer the first optical data signal from the first propagation mode 106A of the few-mode fiber 108 into a third single-mode fiber 110A. The demultiplexer 102D can transfer the second optical data signal from the combination of the second propagation mode 106B of the few-mode fiber 108 and the third propagation mode 106C of the few-mode fiber 108 into a fourth single-mode fiber 110B.

By combining the light from the second propagation mode 106B and the third propagation mode 106C to form a single data channel, the demultiplexer 102D can overcome the obstacle of relatively high coupling (or relatively high crosstalk) between the degenerate second propagation mode 106B and third propagation mode 106C of the few-mode fiber 108.

In the preceding example, the second propagation mode 106B and the third propagation mode 106C of the few-mode fiber 108 are degenerate. In some examples, the second propagation mode 106B and the third propagation mode 106C are doubly degenerate. In other words, the second propagation mode 106B and the third propagation mode 106C have the same effective refractive index and are the only two propagation modes of the few-mode fiber 108 that have that effective refractive index. For such double degeneracy, it is possible to combine the light from the degenerate modes into one single-mode fiber (without use of a multimode fiber) with relatively low loss, such as less than 1.76 dB. For example, the light can be combined by using both polarization states of a fundamental propagation mode. If there were three or more propagation modes that have the same or comparable refractive indices, combining the light from the three or more propagation modes (such as for mode-group multiplexing) would incur losses of 1.76 dB or more, with losses comparable to the losses that arise from use of a beamsplitter.

In some examples, the second propagation mode 106B and the third propagation mode 106C achieve their degeneracy through symmetry. For example, for a few-mode fiber 108 having a refractive index profile that is rotationally symmetric about a longitudinal axis of the few-mode fiber 108, there can be two modes, having orthogonal polarization states, that have identical effective refractive indices. This is referred to as symmetry-based degeneracy. Because of symmetry-based degeneracy, a rotational symmetry of the refractive index profile can ensure that there are two propagation modes that have identical effective refractive indices. In some examples, the few-mode fiber 108 can include multiple sets of degenerate modes, such as a first pair of symmetry-based degenerate propagation modes that have a first effective refractive index and a second pair of symmetry-based degenerate propagation modes that have a second effective refractive index different from the first effective refractive index.

There can also be configurations in which the degeneracy is not achieved through symmetry, for which the effective refractive indices are not identical but differ by less than a specified effective refractive index threshold. Suitable effective refractive index thresholds can include numerical values of 104, 10-5, 106, 10-7, 10-8, 10-9, 10-10, or other suitable values.

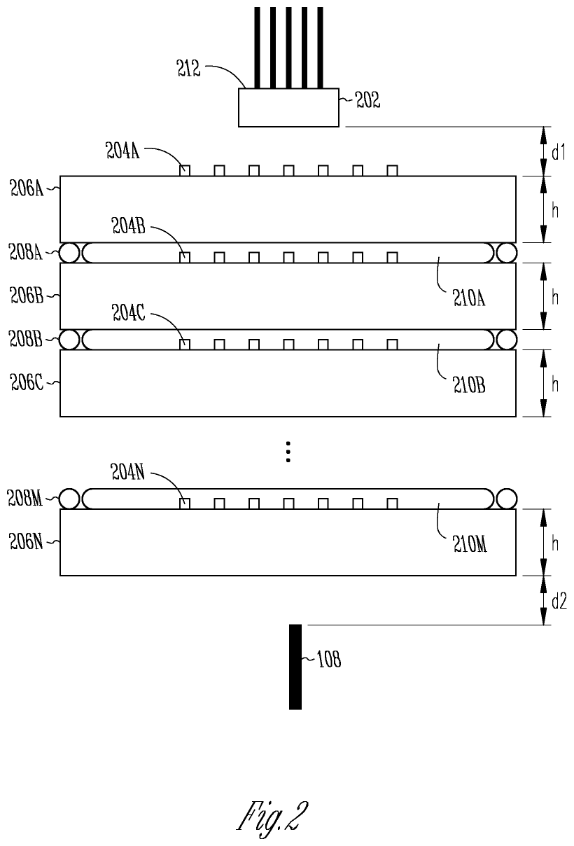

FIG. 2 shows a side-view drawing of an example of a configuration for one or more metasurface elements of the multiplexer/demultiplexer 102 of FIG. 1. The configuration and elements shown in FIG. 2 can be used for the multiplexer 102M, the demultiplexer 102D, or both the multiplexer 102M and the demultiplexer 102D.

Metasurface elements can include subwavelength-spaced arrays of nanostructures. The nanostructures can control the phase, amplitude, and polarization of light with very high spatial resolution, such as less than a wavelength. In some examples, each nanostructure can have a value of birefringence and an orientation, with the values of birefringence and the orientations varying from nanostructure to nanostructure. In some examples, the metasurface elements can include multiple layers of nanostructures, so that incident light passes through a first layer of nanostructures, then passes through a second layer of nanostructures, and so forth. In some examples, two or more layers can be formed directly upon one another. In some examples, two or more layers can be separated longitudinally by a layer or by formation on separate substrates.

By varying dimensions and geometry of the nanostructures, each nanostructure on the metasurface element can be designed with anisotropic behavior, which can mimic the function of waveplates and/or polarizers. This birefringent behavior allows metasurface elements to manipulate the spatial and polarization degrees of freedom of light, with extremely high resolution. For example, the dimensions and/or geometry of the nanostructures can vary from nanostructure to nanostructure. Such manipulation of the spatial and polarization degrees of freedom of light is well-suited for mode division multiplexing. The phase and birefringence profile of the metasurface elements can be designed using numerical optimization, such as the technique of adjoint analysis. In addition to high spatial resolution, metasurface elements can provide multiple optical functions on a single metasurface element and can be fabricated relatively easily using conventional manufacturing techniques. For example, a top-down approach for forming a metasurface element can include growing a thin film on a substrate, coating the thin film with photoresist, using lithography to define features (using e-beam, photolithography, and/or nanoimprint techniques), etching around the features, adding cladding material, and adding an optional reflective layer (such as a metal layer). As another example, a bottom-up approach forming a metasurface element can include coating photoresist on a substrate, using lithography to define features in the photoresist, growing a thin film on the photoresist, lifting the thin film off (which can remove all but the defined features), adding a cladding material, and adding an optional reflective layer (such as a metal layer). Other suitable design and manufacturing techniques can also be used. For fabrication of metasurface elements that include multiple layers of nanostructures, either the top-down approach and/or bottom-up approach can be repeated per layer of nanostructures.

In some examples, the first single-mode fiber 104A and the second single-mode fiber 104B can be included in a single-mode fiber array 202. The single-mode fiber array 202 can optionally include a common housing 212, such as a ferrule, that protects the single-mode fibers in the array 202 (such as 104A, 104B, . . . , 104N and/or 110A, 110B, . . . 110N) during assembly and alignment of the optical communication system 100. The housing 212 can optionally have relatively tight mechanical tolerances. The housing 212, with tight tolerances, can be manufactured separately from the single-mode fibers, and can optionally relax some of the manufacturing tolerances for the single-mode fibers. The housing 212 can optionally be included as a portion of a connector or can be attachable to a connector.

In some examples, the multiplexer/demultiplexer 102 includes one or more metasurface elements 204A, 204B, 204C, . . . , 204N spaced apart along an optical path between the single-mode fiber array 202 and the few-mode fiber 108. Using two or more metasurface elements 204A, 204B, 204C, . . . , 204N sequentially and spaced apart along the optical path can provide additional flexibility for redirecting light rays, compared to using a single metasurface element. For example, using two spaced-apart metasurface elements can allow the multiplexer/demultiplexer 102 to control both the position and propagation angle of a particular light ray; controlling both position and propagation angle can be challenging with some configurations that use only a single metasurface element. In a specific example, an arriving light ray (arriving at the multiplexer/demultiplexer 102) can be traced forward to strike a particular location on a first metasurface element, a departing light ray (departing from the multiplexer/demultiplexer 102) can be traced backward to a second metasurface element, the first metasurface element can be configured to redirect the arriving light ray to propagate to the particular location on the second metasurface element, and the second metasurface element can be configured to redirect the ray from the particular location on the second metasurface element to coincide with the departing light ray. This is but one specific example. The multiplexer/demultiplexer 102 can optionally include more than two metasurface elements 204A, 204B, 204C, . . . , 204N along the optical path. Increasing the number of sequential and spaced-apart metasurface elements 204A, 204B, 204C, . . . , 204N can loosen some of the manufacturing tolerances and/or alignment tolerances on the metasurface elements 204A, 204B, 204C, . . . , 204N.

Each metasurface element 204A, 204B, 204C, . . . , 204N is configured to impart a polarization-dependent phase onto the first optical data signal and the second optical data signal. The polarization-dependent phase can vary as a function of location over each metasurface element 204A, 204B, 204C, . . . , 204N. For example, a metasurface element 204A, 204B, 204C, . . . , 204N can have a first area having a first value of phase and a second area having a second value of phase. The spatially varying polarization-dependent phase of the metasurface elements 204A, 204B, 204C, . . . , 204N can perform various optical tasks simultaneously, such as focusing and beamshaping (e.g., converting light from a first intensity distribution to a second intensity distribution).

The polarization-dependent phase can allow the first optical data signal to transfer between the first single-mode fiber 104A (FIG. 1) and the first propagation mode 106A (FIG. 1) of the few-mode fiber 108. The polarization-dependent phase can allow the second optical data signal to transfer between the second single-mode fiber 104B (FIG. 1) and the combination of the second propagation mode 106B (FIG. 1) of the few-mode fiber 108 and the third propagation mode 106C (FIG. 1) of the few-mode fiber 108.

One or more of the metasurface elements 204A, 204B, 204C, . . . , 204N can operate in transmission. In some examples, the plurality of metasurface elements 204A, 204B, 204C, . . . , 204N are disposed on surfaces of corresponding substrates 206A, 206B, 206C, . . . , 206N. The multiplexer/demultiplexer 102 can impart the polarization-dependent phase by transmitting the first optical data signal and the second optical data signal through the substrates and through the plurality of metasurface elements.

In some examples, the substrates 206A, 206B, 206C, . . . , 206N have the same thickness (h). Alternatively, at least two of the substrates 206A, 206B, 206C, . . . , 206N can have different thicknesses. In some examples, the substrates 206A, 206B, 206C, . . . , 206N are spaced apart by spacers 208A, 208B, . . . 208M, which can be formed from a solid material. In some examples, the volume between adjacent substrates 206A, 206B, 206C, . . . , 206N can be at least partially filled by a fluid or a solid material 210A, 210B, . . . , 210M. Such a fluid or solid material can be a high-refractive-index material encapsulating the surface elements 204A, 204B, 204C, . . . , 204N, and can optionally reduce losses due to reflections that occur when light enters or exits the substrates. In some examples, the single-mode fiber array 202 can be spaced apart from the first metasurface elements 204A by a distance d1. In some examples, the last substrate 206N can be spaced apart from the few-mode fiber 108 by a distance d2, which may be different than distance d1.

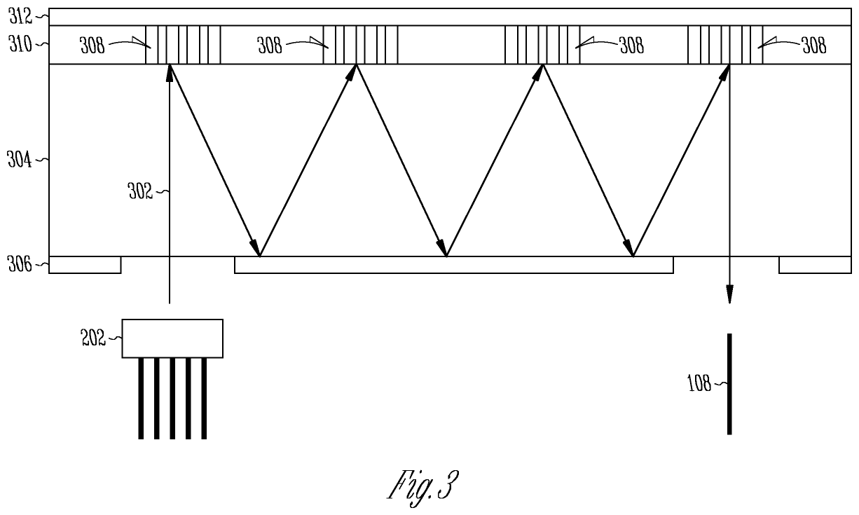

FIGS. 3-7 show examples of configurations for the multiplexer/demultiplexer 102 of FIG. 1 in which one or more of the metasurface elements operate in reflection. In some examples, such as the configurations shown in FIGS. 3-7 and described below, the plurality of metasurface elements can be disposed on at least one of two opposing surfaces of a substrate. The multiplexer/demultiplexer 102 can impart the polarization-dependent phase by transferring the first optical data signal and the second optical data signal into the substrate, reflecting the first optical data signal and the second optical data signal sequentially from the plurality of metasurface elements, and transferring the first optical data signal and the second optical data signal out of the substrate.

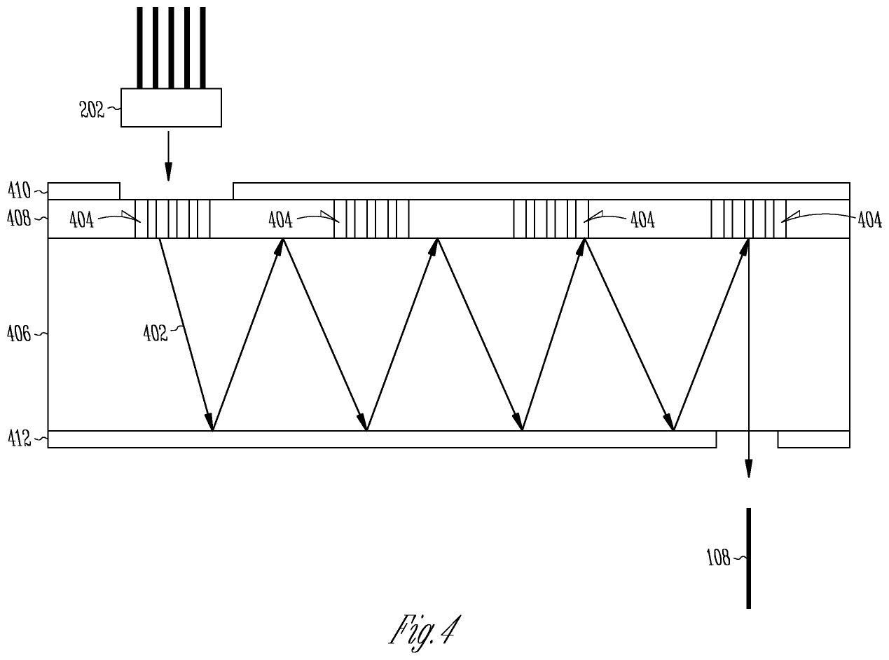

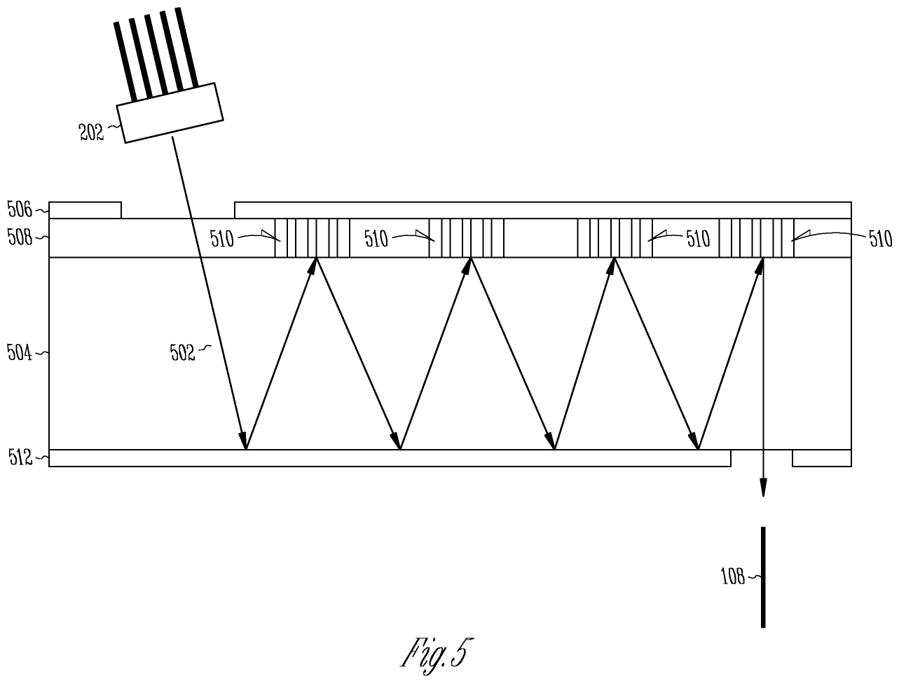

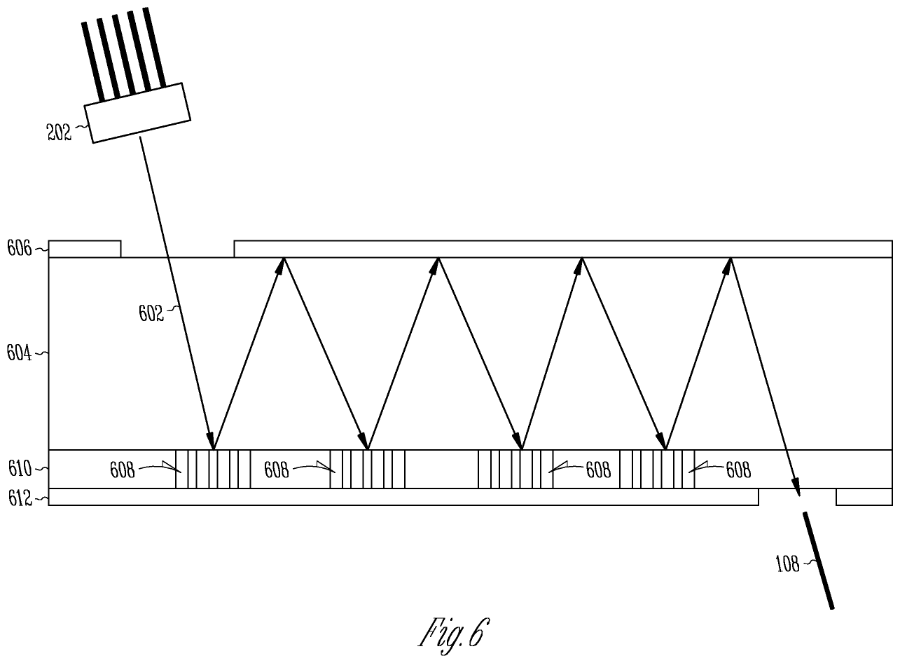

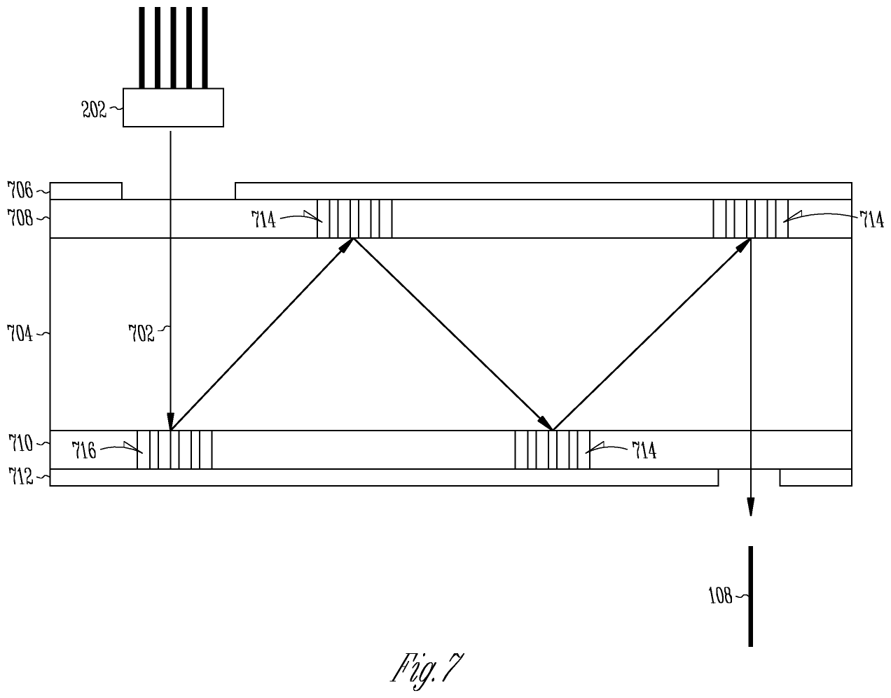

There are at least four factors that can be adjusted to achieve the configurations shown in FIGS. 3-7 as well as other suitable configurations not explicitly shown in the figures. A first factor is placement of the single-mode fiber array and the few-mode fiber. In some examples, such as the configuration of FIG. 3, the single-mode fiber array and the few-mode fiber are located on the same side of the substrate. In other examples, such as the configurations of FIGS. 4-7, the single-mode fiber array and the few-mode fiber are located on opposite sides of the substrate. A second factor is placement of the metasurface elements. In some examples, such as the configurations of FIGS. 3-6, the metasurface elements are located on the same side of the substrate. In other examples, such as the configuration of FIG. 7, the metasurface elements are located on opposite sides of the substrate. A third factor is orientation of the input beam. In some examples, such as the configurations of FIGS. 3, 4, and 7, the input beam is orthogonal relative to the substrate. In other examples, such as the configurations of FIGS. 5 and 6, the input beam is non-orthogonal relative to the substrate. A fourth factor is orientation of the output beam. In some examples, such as the configurations of FIGS. 3-5 and 7, the output beam is orthogonal relative to the substrate. In other examples, such as the configuration of FIG. 6, the output beam is non-orthogonal relative to the substrate. Of the sixteen possible permutations of these factors, five examples are shown explicitly in FIGS. 3-7; it will be understood that the other eleven permutations will be readily understood by one of ordinary skill in the art in view of FIGS. 3-7.

FIG. 3 shows a side-view drawing of an example of a configuration for the multiplexer/demultiplexer 102 of FIG. 1.

In the configuration of FIG. 3, an optical path 302 can extend from the single-mode fiber array 202 into a substrate 304, through a hole or gap in a reflective layer 306, such as a metallic reflective layer. The optical path can extend to a first metasurface element 308. The first metasurface element 308 can be embedded or formed in a metasurface element layer 310, such as by lithographic techniques, etching, depositing and/or growing of materials, and the like. An additional reflective layer 312 can be disposed on the metasurface element layer 310 to increase a reflectivity of the metasurface elements 308. The optical path can go back and forth between the metasurface elements 308 and the reflective layer 306. The optical path can emerge from the substrate 304, through a hole or gap in the reflective layer 306, to the few-mode fiber 108. Light traversing the optical path 302 can propagate from the single-mode fiber array 202 to the few-mode fiber 108 (as for a multiplexer) or from the few-mode fiber 108 to the single-mode fiber array 202 (as for a demultiplexer).

In the configuration of FIG. 3, the single-mode fiber array 202 and the few-mode fiber 108 are disposed on the same side of the substrate 304, and the metasurface elements 308 are disposed on the opposite side of the substrate 304. The single-mode fiber array 202 and the few-mode fiber 108 can be generally parallel to each other and generally orthogonal to a plane of the substrate 304.

FIG. 4 shows a side-view drawing of an example of a configuration for the multiplexer/demultiplexer 102 of FIG. 1.

In the configuration of FIG. 4, an optical path 402 can extend from the single-mode fiber array 202 to a first metasurface element 404 disposed on a substrate 406. The first metasurface element 404 can be embedded or formed in a metasurface element layer 408 disposed on the substrate 406. A reflective layer 410, such as a metallic reflective layer, can be disposed on the metasurface element layer 408, and the optical path 402 can extend through a hole or gap in the reflective layer 410. An opposing reflective layer 412 can be disposed on the opposite side of the substrate 406, opposite to the metasurface element layer 408 to increase a reflectivity of the metasurface elements 404. The optical path can go back and forth between the metasurface elements 404 and the opposing reflective layer 412. The optical path can emerge from the substrate 406, through a hole or gap in the opposing reflective layer 412, to the few-mode fiber 108. Light traversing the optical path 402 can propagate from the single-mode fiber array 202 to the few-mode fiber 108 (as for a multiplexer) or from the few-mode fiber 108 to the single-mode fiber array 202 (as for a demultiplexer).

In the configuration of FIG. 4, the single-mode fiber array 202 and the few-mode fiber 108 are disposed on opposite sides of the substrate 406. The metasurface elements 404 and the single-mode fiber array 202 are disposed on the same side of the substrate 406. The single-mode fiber array 202 and the few-mode fiber 108 can be generally parallel to each other and generally orthogonal to a plane of the substrate 406.

FIG. 5 shows a side-view drawing of an example of a configuration for the multiplexer/demultiplexer 102 of FIG. 1.

In the configuration of FIG. 5, an optical path 502 can extend from the single-mode fiber array 202 to a substrate 504 through a hole or gap in a reflective layer 506 and through a transparent portion of a metasurface element layer 508. Metasurface elements 510 can be embedded or formed in the metasurface element layer 508. An opposing reflective layer 512, such as a metallic reflective layer, can be disposed on the opposite side of the substrate 504. The optical path can move back and forth between the metasurface elements 510 and the opposing reflective layer 512. The optical path can emerge from the substrate 504, through a hole or gap in the opposing reflective layer 512, to the few-mode fiber 108. Light traversing the optical path 502 can propagate from the single-mode fiber array 202 to the few-mode fiber 108 (as for a multiplexer) or from the few-mode fiber 108 to the single-mode fiber array 202 (as for a demultiplexer).

In the configuration of FIG. 5, the single-mode fiber array 202 and the few-mode fiber 108 are disposed on opposite sides of the substrate 504. The metasurface elements 510 and the single-mode fiber array 202 are disposed on the same side of the substrate 504. The single-mode fiber array 202 can be angled (e.g., non-orthogonal) to a plane of the substrate 504. The few-mode fiber 108 can be generally orthogonal to the plane of the substrate 504.

FIG. 6 shows a side-view drawing of an example of a configuration for the multiplexer/demultiplexer 102 of FIG. 1.

In the configuration of FIG. 6, an optical path 602 can extend from the single-mode fiber array 202 to a substrate 604 through a hole or gap in a reflective layer 606. The optical path 602 can extend to a metasurface element 608 disposed on an opposite side of the substrate 604. Metasurface elements 608 can be embedded or formed in a metasurface element layer 610. An opposing reflective layer 612, such as a metallic reflective layer, can be disposed on the metasurface element layer 610. The optical path 602 can go back and forth between the metasurface elements 608 and the reflective layer 606. The optical path 602 can emerge from the substrate 604, through a transparent portion of a metasurface element layer 610, through a hole or gap in the opposing reflective layer 612, to the few-mode fiber 108. Light traversing the optical path 602 can propagate from the single-mode fiber array 202 to the few-mode fiber 108 (as for a multiplexer) or from the few-mode fiber 108 to the single-mode fiber array 202 (as for a demultiplexer).

In the configuration of FIG. 6, the single-mode fiber array 202 and the few-mode fiber 108 are disposed on opposite sides of the substrate 604. The metasurface elements 608 and the few-mode fiber 108 are disposed on the same side of the substrate 604. The single-mode fiber array 202 can be angled (e.g., non-orthogonal) to a plane of the substrate 604. The few-mode fiber 108 can be angled (e.g., non-orthogonal) to the plane of the substrate 604.

FIG. 7 shows a side-view drawing of an example of a configuration for the multiplexer/demultiplexer 102 of FIG. 1.

In the configuration of FIG. 7, an optical path 702 can extend from the single-mode fiber array 202 to a substrate 704 through a hole or gap in a reflective layer 706 and through a transparent portion of a metasurface element layer 708. The optical path 702 can extend through the substrate to a metasurface element layer 710 on an opposite side of the substrate 704. An opposing reflective layer 712, such as a metallic reflective layer, can be disposed on the metasurface element layer 710. In this configuration, there are metasurface element layers 708, 710 on opposite sides of the substrate 704, with metasurface elements 714 being disposed in the metasurface element layer 708 and metasurface elements 716 being disposed in the metasurface element layer 710. The optical path 702 can go back and forth between the metasurface elements 714 and the metasurface elements 716. The optical path 702 can emerge from the substrate 704, through a transparent portion of the metasurface element layer 710, through a hole or gap in the opposing reflective layer 712, to the few-mode fiber 108. Light traversing the optical path 702 can propagate from the single-mode fiber array 202 to the few-mode fiber 108 (as for a multiplexer) or from the few-mode fiber 108 to the single-mode fiber array 202 (as for a demultiplexer).

In the configuration of FIG. 7, the single-mode fiber array 202 and the few-mode fiber 108 are disposed on opposite sides of the substrate 704. The metasurface elements 714 are disposed on one side of the substrate 704, and the metasurface elements 716 are disposed on the opposite side of the substrate 704. The single-mode fiber array 202 can be orthogonal to a plane of the substrate 704. The few-mode fiber 108 can be orthogonal to the plane of the substrate 704.

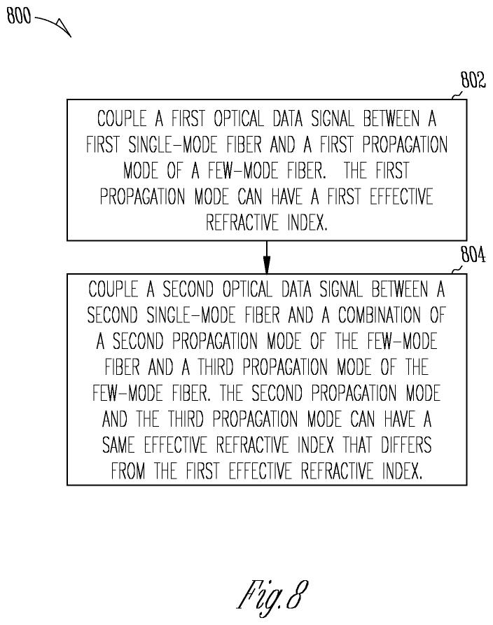

FIG. 8 shows a flow chart of an example of a method 800 for operating an optical communication system. The method 800 can be executed by the optical communication system 100 of FIG. 1, or by another suitable optical communication system. The method 800 is but one method for operating an optical communication system; other suitable methods can also be used.

At operation 802, the optical communication system can transfer, with a multiplexer/demultiplexer, a first optical data signal between a first single-mode fiber and a few-mode fiber. The first optical data signal can be transferred between the fundamental mode of the first single-mode fiber and the first propagation mode of the few-mode fiber. The first propagation mode can have a first effective refractive index.

At operation 804, the optical communication system can transfer, with the multiplexer/demultiplexer, a second optical data signal between a second single-mode fiber and the few-mode fiber. The second optical signal can be transferred between the fundamental mode of the second single-mode fiber and a combination of a second propagation mode of the few-mode fiber and a third propagation mode of the few-mode fiber. The second propagation mode and the third propagation mode can have a same effective refractive index that differs from the first effective refractive index.

In some examples, the first single-mode fiber and the second single-mode fiber can be included in a single-mode fiber array. In some examples, the multiplexer/demultiplexer can include a plurality of metasurface elements spaced apart along an optical path between the single-mode fiber array and the few-mode fiber. In some examples, the method can further include directing the first optical data signal and the second optical data signal onto the plurality of metasurface elements. In some examples, the method can further include imparting, with the metasurface elements, a polarization-dependent phase onto first optical data signal and the second optical data signal. The polarization-dependent phase can vary as a function of location on each metasurface element. In some examples, the method can further include allowing, via imparting of the polarization-dependent phase, the first optical data signal to transfer between the first single-mode fiber and the first propagation mode of the few-mode fiber. In some examples, the method can further include allowing, via imparting of the polarization-dependent phase, the second optical data signal to transfer between the second single-mode fiber and the combination of the second propagation mode of the few-mode fiber and the third propagation mode of the few-mode fiber.

In some examples, during propagation within the few-mode fiber, the second optical data signal can couple bidirectionally between the second propagation mode and the third propagation mode. In some examples, during propagation within the few-mode fiber, the second optical data signal can be substantially isolated from the first propagation mode. In some examples, during propagation within the few-mode fiber, the first optical data signal can be substantially isolated from the second propagation mode and substantially isolated from the third propagation mode.

In some examples, the plurality of metasurface elements can be disposed on surfaces of corresponding substrates. In some examples, imparting the polarization-dependent phase can include transferring the first optical data signal and the second optical data signal through the substrates and through the plurality of metasurface elements.

In some examples, the plurality of metasurface elements can be disposed on at least one of two opposing surfaces of a substrate. In some examples, imparting the polarization-dependent phase can include transferring the first optical data signal and the second optical data signal into the substrate, reflecting the first optical data signal and the second optical data signal from the plurality of metasurface elements, and transferring the first optical data signal and the second optical data signal out of the substrate.

1. An optical communication system, comprising:
a multiplexer/demultiplexer configured to:
transfer a first optical data signal between a first single-mode fiber and a first propagation mode of a few-mode fiber, the first propagation mode having a first effective refractive index; and
transfer a second optical data signal between a second single-mode fiber and a combination of a second propagation mode of the few-mode fiber and a third propagation mode of the few-mode fiber, the second propagation mode and the third propagation mode having a second effective refractive index that differs from the first effective refractive index.

2. The optical communication system of claim 1, wherein the second propagation mode and the third propagation mode are the only two propagation modes of the few-mode fiber that have the second effective refractive index.

3. The optical communication system of claim 1, wherein the second propagation mode and the third propagation mode have a symmetry-based degeneracy.

4. The optical communication system of claim 1, wherein the few-mode fiber has a refractive index profile that is rotationally symmetric about a longitudinal axis of the few-mode fiber.

5. The optical communication system of claim 1, wherein the first single-mode fiber and the second single-mode fiber are included in a single-mode fiber array.

6. The optical communication system of claim 5, wherein:
the multiplexer/demultiplexer includes a metasurface element disposed along an optical path between the single-mode fiber array and the few-mode fiber;
the metasurface element is configured to impart a polarization-dependent phase onto the first optical data signal and the second optical data signal;
the polarization-dependent phase varies as a function of location on the metasurface element;
the polarization-dependent phase is configured to cause the first optical data signal to transfer between the first single-mode fiber and the first propagation mode of the few-mode fiber; and
the polarization-dependent phase is configured to cause the second optical data signal to transfer between the second single-mode fiber and the combination of the second propagation mode of the few-mode fiber and the third propagation mode of the few-mode fiber.

7. The optical communication system of claim 6, wherein the metasurface element includes an array of nanostructures, each nanostructure having a value of birefringence and an orientation, the values of birefringence and the orientations varying from nanostructure to nanostructure.

8. The optical communication system of claim 5, wherein:
the multiplexer/demultiplexer includes a plurality of metasurface elements spaced apart along an optical path between the single-mode fiber array and the few-mode fiber;
each metasurface element is configured to impart a polarization-dependent phase onto the first optical data signal and the second optical data signal;
the polarization-dependent phase varies as a function of location on each metasurface element;
the polarization-dependent phase is configured to allow the first optical data signal to transfer between the first single-mode fiber and the first propagation mode of the few-mode fiber; and
the polarization-dependent phase is configured to allow the second optical data signal to transfer between the second single-mode fiber and the combination of the second propagation mode of the few-mode fiber and the third propagation mode of the few-mode fiber.

9. The optical communication system of claim 8, wherein:
the plurality of metasurface elements are disposed on surfaces of corresponding substrates; and
the multiplexer/demultiplexer is configured to impart the polarization-dependent phase by transferring the first optical data signal and the second optical data signal through the substrates and through the plurality of metasurface elements.

10. The optical communication system of claim 8, wherein:
the plurality of metasurface elements are disposed on at least one of two opposing surfaces of a substrate; and
the multiplexer/demultiplexer is configured to impart the polarization-dependent phase by transferring the first optical data signal and the second optical data signal into the substrate, reflecting the first optical data signal and the second optical data signal from the plurality of metasurface elements, and transferring the first optical data signal and the second optical data signal out of the substrate.

11. The optical communication system of claim 1, wherein during propagation within the few-mode fiber:
the second optical data signal couples bidirectionally between the second propagation mode and the third propagation mode;
the second optical data signal is substantially isolated from the first propagation mode; and
the first optical data signal is substantially isolated from the second propagation mode and substantially isolated from the third propagation mode.

12. The optical communication system of claim 1, wherein:
the first propagation mode is a transverse electric mode or a transverse magnetic mode of the few-mode fiber;
the second propagation mode and the third propagation mode each are a hybrid electric mode of the few-mode fiber.

13. The optical communication system of claim 1, wherein:
a cross-section of a core of the few-mode fiber, taken orthogonal to a longitudinal axis of the few-mode fiber, has a rotationally symmetric shape that defines a radial direction and a tangential direction;
the first propagation mode includes only light having a polarization orientation that is parallel to the radial direction or parallel to the tangential direction; and
the second propagation mode and the third propagation mode each include at least some light having a polarization orientation that is angled with respect to the radial direction and angled with respect to the tangential direction.

14. A method for operating an optical communication system, the method comprising:
coupling, with a multiplexer/demultiplexer, a first optical data signal between a first single-mode fiber and a first propagation mode of a few-mode fiber, the first propagation mode having a first effective refractive index; and
coupling, with the multiplexer/demultiplexer, a second optical data signal between a second single-mode fiber and a combination of a second propagation mode of the few-mode fiber and a third propagation mode of the few-mode fiber, the second propagation mode and the third propagation mode having a second effective refractive index that differs from the first effective refractive index.

15. The method of claim 14, wherein:
the first single-mode fiber and the second single-mode fiber are included in a single-mode fiber array;
the multiplexer/demultiplexer includes a plurality of metasurface elements spaced apart along an optical path between the single-mode fiber array and the few-mode fiber; and
the method further comprises:
directing the first optical data signal and the second optical data signal onto the plurality of metasurface elements;
imparting, with the metasurface elements, a polarization-dependent phase onto first optical data signal and the second optical data signal, the polarization-dependent phase varying as a function of location on each metasurface element;
allowing, via imparting of the polarization-dependent phase, the first optical data signal to transfer between the first single-mode fiber and the first propagation mode of the few-mode fiber; and
allowing, via imparting of the polarization-dependent phase, the second optical data signal to transfer between the second single-mode fiber and the combination of the second propagation mode of the few-mode fiber and the third propagation mode of the few-mode fiber.

16. The method of claim 14, wherein during propagation within the few-mode fiber:
the second optical data signal couples bidirectionally between the second propagation mode and the third propagation mode;
the second optical data signal is substantially isolated from the first propagation mode; and
the first optical data signal is substantially isolated from the second propagation mode and substantially isolated from the third propagation mode.

17. The method of claim 14, wherein:
the plurality of metasurface elements are disposed on surfaces of corresponding substrates; and
imparting the polarization-dependent phase includes transferring the first optical data signal and the second optical data signal through the substrates and through the plurality of metasurface elements.

18. The method of claim 14, wherein:
the plurality of metasurface elements are disposed on at least one of two opposing surfaces of a substrate; and
imparting the polarization-dependent phase includes transferring the first optical data signal and the second optical data signal into the substrate, reflecting the first optical data signal and the second optical data signal from the plurality of metasurface elements, and transferring the first optical data signal and the second optical data signal out of the substrate.

19. An optical communication system, comprising:
a multiplexer configured to:
transfer a first optical data signal from a first single-mode fiber of a first single-mode fiber array into a first propagation mode of a few-mode fiber, the first propagation mode having a first effective refractive index, the few-mode fiber having a refractive index profile that is rotationally symmetric about a longitudinal axis of the few-mode fiber; and
transfer a second optical data signal from a second single-mode fiber of the first single-mode fiber array into at least one of a second propagation mode of the few-mode fiber and a third propagation mode of the few-mode fiber, the second propagation mode and the third propagation mode having a second effective refractive index that differs from the first effective refractive index, the second propagation mode and the third propagation mode being the only propagation modes of the few-mode fiber that have the second effective refractive index; and
a demultiplexer configured to:
transfer the first optical data signal from the first propagation mode of the few-mode fiber into a third single-mode fiber of a second single-mode fiber array; and
transfer the second optical data signal from the combination of the second propagation mode of the few-mode fiber and the third propagation mode of the few-mode fiber into a fourth single-mode fiber of the second single-mode fiber array.

20. The optical communication system of claim 19, wherein:
the multiplexer includes a plurality of first metasurface elements spaced apart along a first optical path between the first single-mode fiber array and the few-mode fiber;
each first metasurface element is configured to impart a first polarization-dependent phase that varies as a function of location on each first metasurface element;
the first polarization-dependent phase is configured to cause the first optical data signal to transfer from the first single-mode fiber to the first propagation mode of the few-mode fiber;
the first polarization-dependent phase is configured to cause the second optical data signal to transfer from the second single-mode fiber to the combination of the second propagation mode of the few-mode fiber and the third propagation mode of the few-mode fiber;
the demultiplexer includes a plurality of second metasurface elements spaced apart along an optical path between the second single-mode fiber array and the few-mode fiber;
each second metasurface element is configured to impart a second polarization-dependent phase that varies as a function of location on each second metasurface element;
the second polarization-dependent phase is configured to cause the first optical data signal to transfer from the first propagation mode of the few-mode fiber to the third single-mode fiber; and
the second polarization-dependent phase is configured to cause the second optical data signal to transfer from the combination of the second propagation mode of the few-mode fiber and the third propagation mode of the few-mode fiber into the fourth single-mode fiber.
